(19) United States
(12) Patent Application Publication
(10) Pub. No.: US 2026/0130324 A1
(43) Pub. Date: May 14, 2026

(54) METHOD OF PREPARATION AND VALIDATION THROUGH PRECISION OF SELF-SUPPORT TRUNK INJECTION SYRINGE FOR MANAGEMENT OF CANDIDATUS LIBERIBACTER ASIATICUS THROUGH TRUNK INJECTION TECHNIQUE

(71) Applicants: Manoj Kumar Ram, Palm Harbor, FL (US); Logan Piner, Land O Lakes, FL (US); Miomir Vukmirovic, Miami, FL (US); Tanishka Aglave, Valrico, FL (US)

(72) Inventors: Manoj Kumar Ram, Palm Harbor, FL (US); Logan Piner, Land O Lakes, FL (US); Miomir Vukmirovic, Miami, FL (US); Tanishka Aglave, Valrico, FL (US)

(21) Appl. No.: 18/947,347

(22) Filed: Nov. 14, 2024

(51) Int. Cl. A01G 7/06

(52) U.S. Cl. CPC A01G 7/06

(57) ABSTRACT

Our invention is about the modification of the trunk injection syringe for the precise application of oxytetracycline for Huanglongbing (HLB) or the Citrus Greening Disease and different rates of curry leaf extract through trunk injection. The purpose of the adapter is to connect the syringe pump to flexible silicone tubing, which then connects to the threaded needle injector. The purpose of using the flexible silicone tubing is to provide the user with the possibility to hang the spring-loaded syringe from nearby branches since the mechanical contact between the threaded needle and the trunk is not strong enough to directly support the weight of the syringe filled with medicine. qPCR was performed at the end of the experiment to validate bactericide efficacy, and an increase in Ct value. Curry leaves extract-based bactericide formulation can emerge as an effective and sustainable method for citrus greening disease management, bolstering the global citrus industry.

### REFERENCE TO RELATED APPLICATION(S)

This application claims priority to U.S. Provisional Patent Application No. 63/712,858, filed on Oct. 28, 2024, the entire contents of which are fully incorporated herein by reference.

### STATEMENTS REGARDING FEDERALLY SPONSORED RESEARCH

Not applicable.

### REFERENCE TO A SEQUENCE LISTING

Not Applicable

### FIELD OF THE INVENTION

The disclosed technology is about the modification of the trunk injection syringe for the precise application of oxytetracycline for Huanglongbing (HLB) or the Citrus Greening Disease and different rates of curry leaf extract through trunk injection. The purpose of the adapter is to connect the syringe pump to flexible silicone tubing, which then connects to the threaded needle injector is the development of this trunk injection syringe which is used for injecting young trees which for injecting the following objectives 1) Minimize damage to tree trunk 2) Alleviate phytotoxicity 3) Prevent leakage of the treatment during delivery. The 3D printed an adapter and a specially designed, threaded needle injector to gently but firmly attach the injector into commercially available syringe.

### BACKGROUND

Huanglongbing (HLB), or the Citrus Greening Disease, is the most destructive citrus disease worldwide and persists in threatening the sustainability of the Citrus Industry in numerous regions. Initially detected in Florida in 2005, Huanglongbing has resulted in a 74% decline in citrus production volume in the Florida Citrus Industry [1].

Florida has the highest citrus production in the United States ranks among the top three orange producers globally. Since the disease outbreak, the orange acreage and yield in Florida have decreased by 26% and 42%, respectively, while orange production has dropped from 242 million to 104.6 million boxes in 2014 [2]. The disease is estimated to affect 90% of the acreage and 80% of the citrus trees in Florida [3, 4]. Due to these vast losses attributed to the outbreak, it is critical to identify a viable treatment or biological control to manage the disease.

The disease is caused by phloem-limited bacterial pathogen, and foliar application of treatments have demonstrated limited efficacy as the thick cuticle of the leaf impedes penetration and uptake of the foliar-applied treatments [5, 6]. Thus, the current measure for control comprises trunk injection of antibiotics to control the disease. Commercial injection using syringes such as [ArborJet] has been known to impede wound healing and increase internal damage [7], alongside cause leakage of the treatment. Importantly, commercial syringes are optimized for older trees, not younger trees. Recently, there has emerged a growing prominence on citrus greening treatment and prevention for young trees, and there is therefore a need for a trunk injection system standardized for younger trees with high efficacy for therapeutic delivery.

The development of this modified trunk injection syringe is a standardized method for injecting young trees which mainly addresses the following objectives 1) Minimize damage to tree trunk 2) Alleviate phytotoxicity 3) Prevent leakage of the treatment during delivery.

Trunk injection is an alternative management technique for directly applying crop protection materials into the vasculature of a woody plant [8-11]. It has proven to be an effective method for managing fungal pathogens such as Dutch elm disease (Ophiostoma spp.) as well as bacterial pathogens and phytoplasmas such as lethal yellowing of palms (Candidatus Phytoplasma palmae) [13-16] and HLB [17]. Recent studies exhibit dramatic improvements in tree health and physiology after trunk injection of OTC in young citrus trees [10]. Consequently, trunk injection can also be utilized to deliver biological extract-based bactericide for better penetration to the vasculature and enhanced management of (′Las bacteria.

Although it is a valuable technique for treating the vascular system of citrus trees, trunk injection has its problems. Trunk injection also has the disadvantage of potentially causing physical harm to the tree trunk during the drilling operation. The xylem and phloem's nutrition transport system may be disturbed by careless or frequent pruning, according to Shang et al [18, 19], which would progressively compromise the tree. Trunk injections at the injection site, however, might result in long-term discomfort, disease, or possibly a subsequent infestation. Trunk injection, however, has been demonstrated to have more advantages than disadvantages compared to foliar sprays, especially when addressing the problem of thick cuticles on citrus leaves [11]. While foliar sprays are very simple to administer, their inability to reach the vascular system where Candidatus Liberibacter asiaticus is prevalent due to their lack of penetration depth and concentration makes them problematic. Alternatively, by guaranteeing that the targeted tissues, trunk injection boosts the drug's efficacy.

As precision farming technologies have advanced, trunk injection techniques have proven increasingly successful. However, there are certain drawbacks to the trunk injection method, such as precision trunk injection being created to ensure that the required apparatus is adopted and installed. Precision injection can minimize treatment administration frequency, reducing stress on the tree and its potential adverse effects [11]. Furthermore, outside of HLB, trunk injection methods have been effectively used to treat bacterial leaf scorch on oak trees and fire blight on apples [20]. As a result, these studies help prove that trunk injection, a method that may be employed for plant control, is an efficient way to administer different pests and diseases to trees.

The 3-D printed, modified trunk injection syringe is made of a different structural configuration where the syringe tip is smaller in size for smaller trunk diameter and has a ridged structure, serving as a mechanism to prevent treatment leakage. The syringe is also designed for self-support in the tree trunk, enabling sustained delivery of treatments over a longer time interval, optimizing delivery efficiency. Overall, this modified trunk injection syringe acquires immense potential in advancing treatment delivery and disease management in young, infected trees.

Some plant diseases can be treated only by the injection of the medicine directly into the trunk of the tree. For that purpose, spring-loaded syringes (like the Chemjet Tree Injector) are designed to be attached through a pre-drilled hole in the trunk of the tree. This is achieved using a specifically designed tip of the syringe which consists of exterior threads on a large diameter (15 mm) cone, which is threaded into the pre-drilled hole. This approach is appropriate for large-diameter trees since the hole required will not produce significant stress to the tree. However, the use of a large-diameter tip is not applicable to small-diameter trunk (young) trees due to the large-diameter hole necessary for the tip to be inserted into the trunk. Attempting to use this syringe for these small-diameter trees will irreversibly damage the tree.

### SUMMARY OF THE INVENTION

To still make use of this already on the market spring loaded syringes, we invented an adopter (FIG. 1) and specially designed, threaded needle injector (FIG. 2) to gently but firmly attach the injector into the tree with minimal experienced by the young tree. The purpose of the adaptor is to connect the already on the market syringe pump to flexible, food grade, silicone tubing which then connects to the threaded needle injector. The purpose of using the flexible the flexible silicone tubing is to provide the user with the possibility to hang the spring loaded syringe from nearby branches since the mechanical contact between the threaded needle and the trunk is not strong enough to directly support the weight of the syringe filled with medicine.

Huanglongbing (HLB), or the Citrus Greening Disease (Candidates et al.), is the most destructive worldwide and persists in threatening the sustainability of the Citrus Industry in numerous regions. No pesticide is registered to cure this disease besides the antibiotic Oxytetracycline and streptomycin sulfate under the emergency label section 18. The curry leaf tree, Murraya koenigii, is beautiful to the Asian citrus psyllid, Diaphorina citri, the bacterial causative agent of citrus greening disease. However, it is not a carrier of greening disease. This experiment used curry leaf extract to develop a novel bactericide to treat greening infected trees through trunk injection, with Oxytetracycline as the standard control. qPCR was performed at the end of the experiment to validate bactericide efficacy, and an increase in Ct value (33%) was observed in curry leaves extract-treated trees and Oxytetracycline. NDVI index through rapid scan CS45 also showed more than a 15% increase, confirmed with canopy physical measurement where the plant height width increased by 7.5% and 12%. LI-600 was used to measure the stomatal conductance and chlorophyll content. The chlorophyll content assessment confirmed the equivalent efficacy of High-Rate Extract (30%) and the Industry Standard in increasing the photosynthetic activity. No evident difference was found in the stomatal conductance. Among the different rates (10% to 30%) of curry leaf extract, the 30% rate was optimal. Based on the findings, curry leaves extract-based bactericide formulation can emerge as an effective and sustainable method for citrus greening disease management, bolstering the global citrus industry. The experiment will be repeated in the coming season to validate the current findings, and experimental plants will be observed for the next two years as a continuation.

### BRIEF DESCRIPTION OF THE DRAWINGS

FIG. 1 shows the Back view and side view of the adapter and printed adapter next to ruler for scale.

FIG. 2 presents Fronts view and side view of the threaded needle injector and printed threaded needle injector next to ruler for scale.

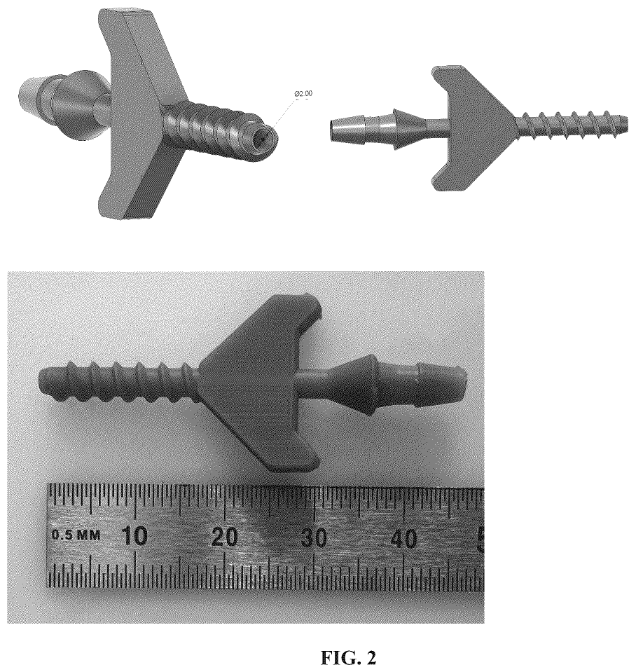

FIG. 3 presents the interior threads of the adaptor (right panel) match the exterior thread of the spring-loaded syringe pump (left panel)

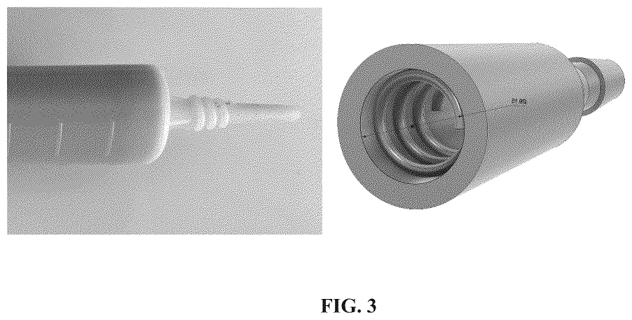

FIG. 4 shows the Sketch (left panel) and physical assembly (right panel) of the spring-loaded syringe, adapter, flexible silicone tubing, and threaded needle injector.

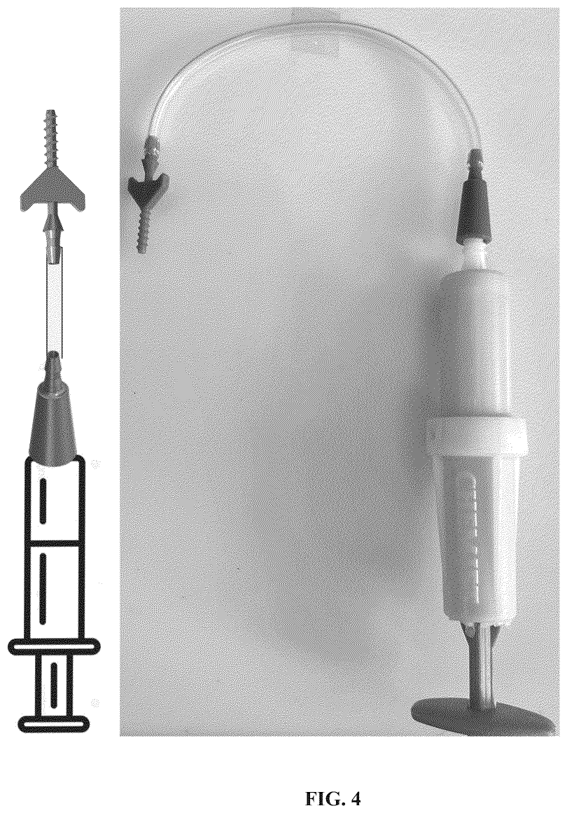

FIG. 5 shows the Sketch of the spring-loaded syringe hanging from a tree branch and the threaded needle injector inserted into the trunk.

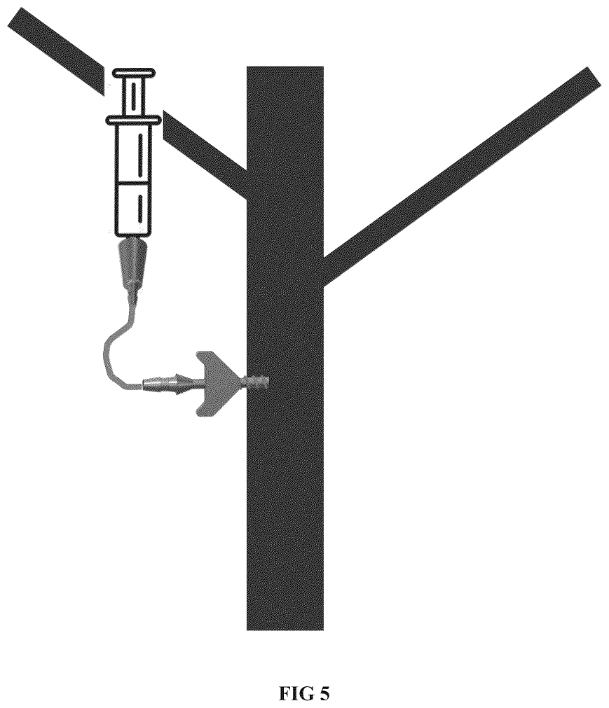

FIG. 6 shows the plant vigor was assessed on a 0-10 scale, 0 indicating a healthy plant and 10 indicating a vigorous plant at 15-day intervals over four months.

FIG. 7 shows the Chlorophyll Content (μmol m−2) was analyzed over monthly intervals using the Field Scout Chlorophyll Fluorometer measuring the maximum chlorophyll a fluorescence absorption. The evaluations were recorded as follows on the following date intervals: A) Sep. 16, 2023 B) Oct. 17, 2023 C) Nov. 16, 2023 D) Dec. 17, 2023.

FIG. 8 shows the Disease Severity on 0-100 scale (0-healthy, 100 severely infected) measured over 15-day intervals. The evaluations for disease severity were conducted by analyzing the leaf samples for standard symptoms of the disease. Leaf samples were taken per treatment group (6 plants per treatment) and evaluated based on % area appearing symptomatic with chlorotic mottling or interveinal chlorosis.

FIG. 9 shows the Post Antibiotic Application PCR Data (Ct) for Quantification Candidatus Liberibacter asiaticus. A CT value below 17 was the benchmark for high bacterial population or infection level, and a CT value above 32 indicated little bacterial presence or eradication of greening bacteria The CT value for UTC (Untreated Control) and LR (Low-Rate Extract) remained relatively similar at 21.3 and 21.2, respectively.

### DETAILED DESCRIPTION OF THE INVENTION

Prior to any embodiments of the invention being disclosed, it is made to know here that it is apparent to an artisan of this field of syringe that the invention described here-in is not limited in its application to the details of syringe making set forth in the following description or illustrated in the following drawings. The invention is capable of other embodiments and of being practiced or of being conducts in various ways.

### 1. Definitions

Unless otherwise defined, all technical and scientific terms used herein have the same meaning as commonly understood by one of ordinary skill in the art. In case of conflict, the present document, including definition, will control. Preferred methods, methodology and materials are described below, although methods and materials similar or equivalent to those described herein can be used in practice or testing of the present invention. All publications, patent applications, patents, and other references mentioned herein are incorporated by reference in their entirety. The materials, methods, and encapsulation invention disclosed herein are illustrative only and not intended to be limiting.

The terms “comprise(s)”, “include(s)”, “having”, “has”, “can”, “contain(s)”, and variants thereof, as used herein, are intended to be open-ended transitional phrases, terms, or words that do not preclude the possibility of additional acts or structures. The singular forms “a,” “and” and “the” include plural references unless the context clearly dictates otherwise. The present disclosure also contemplates other embodiments “comprising,” and “consisting of,” the embodiments or elements presented herein, whether explicitly set forth or not. from the context, such as rounding off, so, for example “about 1” may also mean from 0.5 to 1.4.

The invention described here-in provides a unique adapter, treaded needle injector, application, and the used materials.

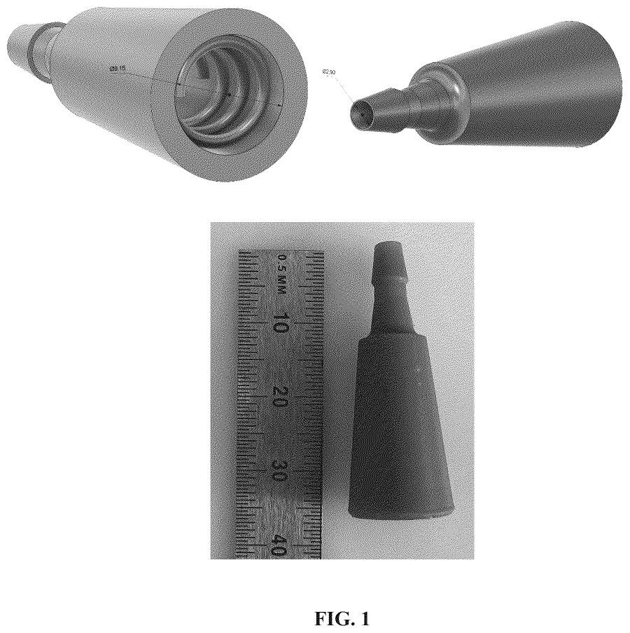

Adapter: The adapter (FIG. 1) is cone shaped with interior threads to match the exterior threads of the spring-loaded syringe pump. It has a barbed tip which can be connected to 3/16″ ID, food grade silicone tubing.

Threaded Needle Injector: The threaded needle injector is a hollow cylinder, 46 mm in length. On one end, it has a barbed tip which can be connected to 3/16″ ID, food grade silicone tubing. The other end is threaded with 0.4 threads/mm to ensure firm contact through the pre-drilled hole. The tip of the threaded end is tapered to allow for easier initial penetration into the trunk. It also has 2 wings to provide the user the ability to apply torque when screwing into the trunk.

Application in the trunk of the tree: First, using a mechanical drill, a 1.5 mm hole is drilled into the trunk of the tree, no deeper than 50% of the trunk's diameter. Next, threaded needle injector is screwed into the pre-drilled hole. Then, the adapter is screwed onto the tip of the spring-loaded syringe. Then, the 20 cm long, 3/16″ ID, food grade silicone tubing is fitted over the barbed end of the adapter, medicine is loaded into the spring-loaded syringe, and the other end of the silicone tubing is fitted over the barbed end of the threaded needle injector.

Materials and Methods of application of syringe in citrus greening infected plants: The experiment was conducted in a greenhouse with 30 citrus greening infected plants. Two-year-old citrus greening infected trees were selected for observation of treatment efficacy. Initially, the plants were screened through qPCR to ensure similar Ct Value and infection level for consistency within the data. Twenty-five psyllids were released per plant with an aspirator, and the plants were covered with insect-proof cages. A total of five treatments were investigated for greening disease management: Three concentrations of the Murraya koenigii extract (High, Medium, and Low concentration) in a liquid formulation were evaluated alongside antibiotic Oxytetracycline as an Industry Standard Control and a separate untreated control group. All treatments were delivered through trunk injection to penetrate the vasculature. The experiment was replicated six times for each of the five treatments over a 4-month interval.

After the trunk injection of the Murraya koeinigii biological formulation and antibiotic oxytetracycline, the comparative treatment efficacy was validated through a combination of qualitative physical parameters and quantitative assessments, which included qPCR, Rapid Scan NDVI and NDRE Vegetation Indices, and Chlorophyll content.

Trunk Injection of Oxytetracycline and Murraya koeinigii Bactericide Formulation: Arbor jet syringes were used for the trunk injection of citrus trees. Two 2-mm holes were drilled into the citrus greening infected trees using a drilling machine. After creating the opening, 100 mL of bactericide solution was injected into each tree for the five treatment groups. The precaution was taken when drilling the holes and delivering the treatment over a 48-hour interval to prevent the disruption of nutrient transport within the xylem and phloem vascular tissue.

Quantification of Candidatus liberibacter asiaticus (CLas) using qPCR.: The DNA was extracted from the infected plant tissue using the Thermo Scientific GeneJet DNA extraction kit. Detailed procedure was as follows: Pipette 350 μL of Lysis Buffer A into a 1.5 mL microcentrifuge tube (not provided). Weigh the plant tissue-use up to 100 mg of fresh or frozen tissue and up to 20 mg of lyophilized tissue. Grind the material using one of the following methods: a) Mortar and pestle. Place up to 100 mg of plant tissue into liquid nitrogen and grind thoroughly with a mortar and pestle. b) Grinding mill. Place 100 mg of tissue into a vial containing stainless steel beads. The vial and beads should be precooled with liquid nitrogen. Immediately transfer the tissue powder into a 1.5 mL microcentrifuge tube containing 350 μL of Lysis Buffer A. Vortex for 10-20 s to mix thoroughly. Transfer the ground tissue to the Lysis Buffer quickly to avoid DNA degradation. All ground material was thoroughly mixed with the Lysis Buffer. Add 50 μL of Lysis Buffer B and 20 μL RNase. Incubate the sample for 10 min at 65° C., vortexing occasionally, or use a shaking water bath, rocking platform, or thermomixer. Add 130 μL of Precipitation Solution and mix by inverting the tube 2-3 times. Incubate 5 min on ice. Centrifuge for 5 min at ≥20,000×g (≥14,000 rpm). Collect the supernatant (usually 450-550 μL) and transfer it to the clean microcentrifuge tube (not provided). Add 400 μL of Plant gDNA Binding Solution and 400 μL of 96% ethanol and mix well. Transfer half of the prepared mixture (600-700 μL) to the spin column. Centrifuge for 1 min at 6,000×g (˜8,000 rpm). Discard the flowthrough solution and apply the remaining mixture to the same column. Centrifuge for 1 min at 6,000×g (˜8,000 rpm). Add 500 μL of Wash Buffer I to the column (ensure ethanol has been added to Wash Buffer I). Centrifuge for 1 min at 8,000×g (˜10,000 rpm). Discard the flowthrough and place the column back into the collection tube. Add 500 μL of Wash Buffer II to the column (ensure ethanol has been added to Wash Buffer II). Centrifuge for 3 min at maximum speed ≥20,000×g (≥14,000 rpm). Recommended: Empty the collection tube. Place the purification column back into the tube and re-spin the column for 1 minute. at maximum speed (≥20,000×g, ≥14,000 rpm). Discard the collection tube containing the flowthrough solution and transfer the column to a sterile 1.5 mL microcentrifuge tube. To elute genomic DNA, add 100 μL of Elution Buffer to the center of the column membrane, incubate for 5 min at room temperature, and centrifuge for 1 min at 8,000×g (˜10,000 rpm). Perform a second elution step using 100 μL Elution Buffer.

### RESULTS AND DISCUSSION

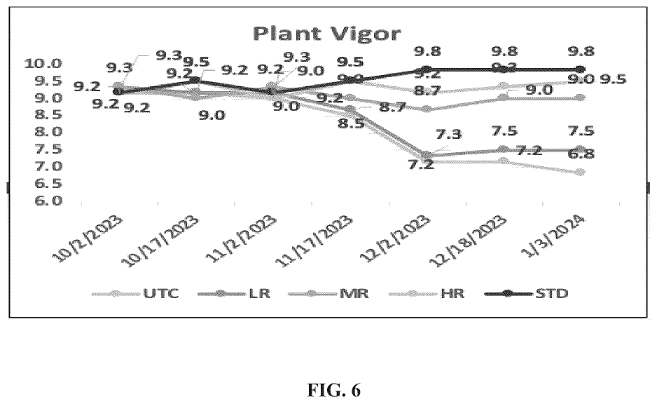

Plant Vigor FIG. 6 shows the plant vigor was assessed on a 0-10 scale, 0 indicating a healthy plant and 10 indicating a vigorous plant at 15-day intervals over four months. The qualitative benchmarks used for evaluations included tree height, maximum number of leaves per branch, canopy density, and overall greenness of foliage. Average vigor of the treatment group was calculated per evaluation. Both the High-Rate extract (HR) and Medium Rate Extract (MR) exhibited an increase in plant vigor, in which HR demonstrated a more sustained efficacy in improving plant health and progressively with a final vigor rating of 7.5. The low-rate treatment and untreated control demonstrated an overall decline or deterioration in health over time.

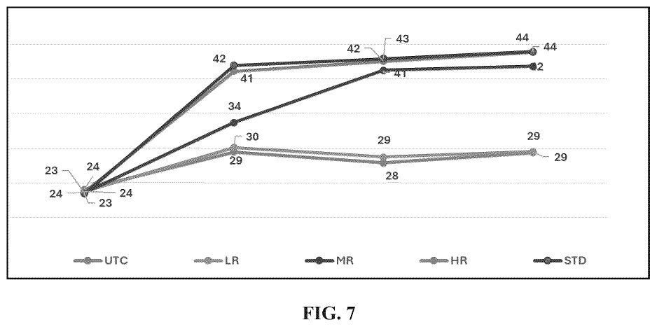

Chlorophyll Content: FIG. 7 shows the Chlorophyll Content (μmol m−2) was analyzed over monthly intervals using the Field Scout Chlorophyll Fluorometer measuring the maximum chlorophyll a fluorescence absorption. The evaluations were recorded as follows on the following date intervals: A) Sep. 16, 2023 B) Oct. 17, 2023 C) Nov. 16, 2023 D) Dec. 17, 2023. By the final evaluation, an equivalent efficacy was observed in the high-rate extract (HR) and Oxytetracycline (STD), suggesting that both were highly effective in increasing the photosynthetic rate.

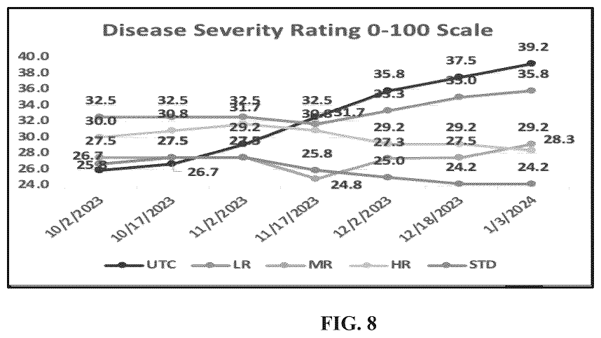

Disease Severity FIG. 8. Disease Severity on 0-100 scale (0-healthy, 100 severely infected) measured over 15-day intervals. The evaluations for disease severity were conducted by analyzing the leaf samples for standard symptoms of the disease. Leaf samples were taken per treatment group (6 plants per treatment) and evaluated based on % area appearing symptomatic with chlorotic mottling or interveinal chlorosis. An average was then taken from the ratings. MR (Medium Rate), HR (High Rate), and STD (Standard) treatment groups exhibited a progressive decline in severity from the third-fourth evaluation (30-45 days) with final ratings of 29.2, 28.3, and 24.2, respectively. Considering the time span of the evaluations ranged from October to January and efficacy peaked around late November to Early December, it is likely that treatment penetration was enhanced by flushing seasons or flush formation.

Table 1. NDVI/NDRE vegetation indices were measured by the CS45 Rapid Scan Hand Sensor Device for the following treatments: UTC (Untreated Control); LR (Low-Rate Extract); MR (Medium-Rate Extract); HR (High-Rate Extract). NDVI (Normalized Difference Vegetation Index) analyzed the reflection of Near Infrared Light providing an indication of canopy density and overall greenness. Values of 0-0.33 indicate plants of poor health, 0.33-0.66 indicate adequate health, and 0.66-1 indicate high vigor. Normalized Difference Red Edge was used for further reflectance analysis and insights into greenness and photosynthetic rate. After application of treatments, NDVI readings for Low, Medium, and High-rate extract (>0.66) were indicative of a vigorous plant, in which the High-Rate Extract demonstrated readings closely resembling those of Oxytetracycline. This underscores the significance of the high-rate extract in increasing vegetation density.

TABLE 1
NDVI/NDRE Vegetation Indices

| Plot | NDRE | NDVI |
|---|---|---|
| UTC | 0.2377 | 0.4077 |
| LR | 0.2576 | 0.6632 |
| MR | 0.3572 | 0.7669 |
| HR | 0.3577 | 0.7776 |
| Standard Treatment | 0.4033 | 0.7784 |
| (Oxytetracycline) | | |

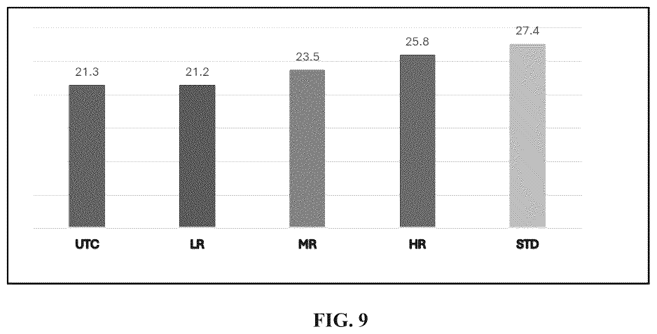

qPCR Data: FIG. 9. Post Antibiotic Application PCR Data (Ct) for Quantification Candidatus Liberibacter asiaticus. A CT value below 17 was the benchmark for high bacterial population or infection level, and a CT value above 32 indicated little bacterial presence or eradication of greening bacteria The CT value for UTC (Untreated Control) and LR (Low-Rate Extract) remained relatively similar at 21.3 and 21.2, respectively. A considerable improvement in CT value was demonstrated after application of MR (Medium-Rate Extract), HR (High-Rate Extract), and Standard Treatment. A 33% improvement was found with HR (CT value 25.8), with the CT value resembling that of Oxytetracline (CT Value 27.4) closely.

Statistical Analysis: An Analysis of Variance (AOV Mean) was conducted through ARM (Agriculture Research Manager) tool, LSD<0.05.

Conclusion: The experiment was conducted to investigate an eco-friendly/biological control measure for the control of Citrus greening disease. The Murraya koenigii extract at mid and high rate demonstrated significant improvements in citrus greening disease control and numerous physiological parameters. Stomatal conductance was high with OTC (19 mms⁻¹) followed by high and mid-rate of curry leaves extract (13%). Ct value has also exhibited improvement after the application of mid and high rate of curry leaves extract (Ct 25) over the Untreated control (Ct 23), in which OTC treatment resulted in the highest efficacy (Ct 27). A similar trend was observed in the chlorophyll content where both mid and high rate were effective in increasing photosynthetic activity like the findings of OTC across different time intervals. Plant vigor also improved substantially with curry leaves extract treatments comparative to the untreated control. Most importantly, qualitative disease severity rating resulted in better disease control with mid and high rate of curry leaves as compared to UTC. Overall, these findings underscore the potential for Murraya koenigii extract based bactericide to serve as a viable biological control measure for Citrus Greening Disease, bolstering the Citrus industry in Florida and globally.

### REFERENCE

1. Singerman, A. and M. E. Rogers, The economic challenges of dealing with citrus greening: the case of Florida. Journal of Integrated Pest Management, 2020. 11(1): p. 3.
2. Etxeberria, E., et al., An improved method to track changes of Candidatus liberibacter asiaticus titer in HLB-affected citrus trees. HortScience, 2019. 54(8): p. 1357-1360.
3. Singerman, A., S. H. Lence, and P. Useche, Is area-wide pest management useful? The case of citrus greening. Applied Economic Perspectives and Policy, 2017. 39(4): p. 609-634.
4. Singerman, A. and P. Useche, The role of strategic uncertainty in area-wide pest management decisions of Florida citrus growers. American Journal of Agricultural Economics, 2019. 101(4): p. 991-1011.
5. Killiny, N., et al., Effect of adjuvants on oxytetracycline uptake upon foliar application in citrus. Antibiotics, 2020. 9(10): p. 677.
6. Killiny, N., The efficacy of Citrus tristeza virus as a vector for virus induced gene silencing in Huanglongbing-affected citrus. Tropical Plant Pathology, 2020. 45(3): p. 327-333.
7. Archer, L. and U. Albrecht, Evaluation of trunk injection techniques for systemic delivery of huanglongbing therapies in citrus. HortScience, 2023. 58(7): p. 768-778.
8. Archer, L., et al., Trunk injection of oxytetracycline for huanglongbing management in mature grapefruit and sweet orange trees. Phytopathology®, 2023. 113(6): p. 1010-1021.
9. Archer, L. and U. Albrecht, Wound reaction to trunk injection of oxytetracycline or water in huanglongbing-affected sweet orange (Citrus sinensis) trees. Trees, 2023. 37(5): p. 1483-1497.
10. Archer, L., J. Qureshi, and U. Albrecht, Efficacy of trunk injected imidacloprid and oxytetracycline in managing huanglongbing and Asian citrus psyllid in infected sweet orange (Citrus sinensis) trees. Agriculture, 2022. 12(10): p. 1592.
11. Li, M. and Z. Nangong, Precision trunk injection technology for treatment of huanglongbing (HLB)-affected citrus trees—A review. Journal of Plant Diseases and Protection, 2022. 129(1): p. 15-34.
12. Haugen, L. and M. Stennes, Fungicide injection to control Dutch elm disease: Understanding the options. Plant Diagnosticians Quarterly, 1999. 20(2): p. 29-38.
13. Bahder, B. W., et al., Digital PCR technology for detection of palm-infecting phytoplasmas belonging to group 16SrIV that occur in Florida. Plant Disease, 2018. 102(5): p. 1008-1014.
14. Harrison, N., E. Helmick, and M. Elliott, Lethal yellowing-type diseases of palms associated with phytoplasmas newly identified in Florida, USA. Annals of Applied Biology, 2008. 153(1): p. 85-94.
15. McCoy, R., D. Thomas, and J. Tsai, Lethal yellowing: a potential danger to date production. Date Palm Journal, 1982. 1: p. 295-305.
16. Soto, N., et al., Genetic variability of palm lethal decline phytoplasmas in the Caribbean basin and Florida, USa, based on a multilocus analysis. Phytopathology®, 2021. 111(12): p. 2203-2212.
17. Hu, J. and N. Wang, Evaluation of the spatiotemporal dynamics of oxytetracycline and its control effect against citrus Huanglongbing via trunk injection. Phytopathology, 2016. 106(12): p. 1495-1503.
18. Shang, P., L. Xu, and T. Cheng, Serological and Molecular Detection of Citrus Tristeza Virus: A Review. Microorganisms, 2024. 12(8): p. 1539.
19. Zhang, W., et al., Mutation of OsNRAMP5 reduces cadmium xylem and phloem transport in rice plants and its physiological mechanism. Environmental Pollution, 2024. 341: p. 122928.
20. Shang, Q., et al., The Advancement and Prospects of the Tree Trunk Injection Technique in the Prevention and Control of Diseases and Pests. Agriculture, 2024. 14(1): p. 107.

We claim:

1. The invention material comprising of 3D printed an adapter and a specially designed, threaded needle injector to gently but firmly attach the injector into available syringe.

2. The material of claim 1 is about 3D printed adaptor which is composed of rugged plastic such as polypropylene and it is cone shaped with interior threads to match the exterior threads of the spring-loaded syringe pump. It has a barbed tip which can be connected to 3/16″ ID, food grade silicone tubing.

3. The materials of claim 1 is also about 3D printed Threaded Needle Injector, which is hollow cylinder, 46 mm in length. On one end, it has a barbed tip which can be connected to 3/16″ ID, food grade silicone tubing. The other end is threaded with 0.4 threads/mm to ensure firm contact through the pre-drilled hole. The tip of the threaded end is tapered to allow for easier initial penetration into the trunk. It also has 2 wings to provide the user the ability to apply torque when screwing into the trunk.

4. These materials of claim 1 is about the application of 3D printed adaptor and 3D printed Threaded Needle Injector connected with food grade silicone tubing inside the trunk of the tree where 1.5 mm hole is drilled with a mechanical drill with no deeper than 50% of the trunk's diameter. Next, the threaded needle injector is screwed into the pre-drilled hole. Then, the adapter is screwed onto the tip of the spring-loaded syringe. Then, the 20 cm long, 3/16″ ID, food grade silicone tubing is fitted over the barbed end of the adapter, medicine is loaded into the spring-loaded syringe, and the other end of the silicone tubing is fitted over the barbed end of the threaded needle injector.

5. The claim 1 is about the experiment conducted in a greenhouse with 30 citrus greening infected plants with selected two-year-old citrus greening infected trees were selected for observation of treatment efficacy. A total of five treatments were investigated for greening disease management: Three concentrations of the Murraya koenigii extract (High, Medium, and Low concentration) in a liquid formulation were evaluated alongside antibiotic Oxytetracycline as an Industry Standard Control and a separate untreated control group. All treatments were delivered through trunk injection to penetrate the vasculature. The experiment was replicated six times for each of the five treatments over a 4-month interval. Both the High-Rate extract (HR) and Medium Rate Extract (MR) exhibited an increase in plant vigor, in which HR demonstrated a more sustained efficacy in improving plant health and progressively with a final vigor rating of 7.5. The low-rate treatment and untreated control demonstrated an overall decline or deterioration in health over time.

6. The claim 1 is about Chlorophyll Content (μmol m−2) was analyzed over monthly intervals using the Field Scout Chlorophyll Fluorometer measuring the maximum chlorophyll a fluorescence absorption. The evaluations were recorded as follows on the following date intervals: A) Sep. 16, 2023 B) Oct. 17, 2023 C) Nov. 16, 2023 D) Dec. 17, 2023. By the final evaluation, an equivalent efficacy was observed in the high-rate extract (HR) and Oxytetracycline (STD), suggesting that both were highly effective in increasing the photosynthetic rate.

7. The claim 1 is about the NDVI readings for Low, Medium, and High-rate extract (>0.66) indicative of a vigorous plant, in which the High-Rate Extract demonstrated readings closely resembling those of Oxytetracycline. This underscores the significance of the high-rate extract in increasing vegetation density.

8. The efficacy of claim 1 syringe can be used for disease severity on 0-100 scale (0-healthy, 100 severely infected) measured over 15-day intervals. The evaluations for disease severity were conducted by analyzing the leaf samples for standard symptoms of the disease. Leaf samples were taken per treatment group (6 plants per treatment) and evaluated based on % area appearing symptomatic with chlorotic mottling or interveinal chlorosis. An average was then taken from the ratings. MR (Medium Rate), HR (High Rate), and STD (Standard) treatment groups exhibited a progressive decline in severity from the third-fourth evaluation (30-45 days) with final ratings of 29.2, 28.3, and 24.2, respectively.

9. The specially designed of claim 1 3D-trunk injection can be applied to cure the bacterial diseases such as citrus canker, Xylella fastidiosa in almond and Xylella fastidiosa in olive.

10. The independent claim is that the specially designed 3D-trunk injection can be applied to cure Elm disease (DED) caused fungal pathogen Ophiostoma novo ulmi, insect pest as emerald ash borer (Agrilus Planipennis) and pine wood nematode (Bursaphelenchus xylophilus) in pine trees.
